(19) United States
(12) Patent Application Publication
(10) Pub. No.: US 2021/0146957 A1
(43) Pub. Date: May 20, 2021

(54) APPARATUS AND METHOD FOR CONTROLLING DRIVE OF AUTONOMOUS VEHICLE

(71) Applicant: LG ELECTRONICS INC., Seoul (KR)

(72) Inventors: Hyunkyu KIM, Seoul (KR); Kibong SONG, Seoul (KR)

(21) Appl. No.: 16/793,326

(22) Filed: Feb. 18, 2020

(30) Foreign Application Priority Data
Nov. 19, 2019 (KR) 10-2019-0148907

(51) Int. Cl. B60W 60/00; G05D 1/00; B60R 22/48; G06K 9/00

(52) U.S. Cl. CPC B60W 60/0016; B60W 2520/10; B60R 22/48; G06K 9/00362; G06K 9/00832; B60R 2022/4891; B60W 2540/00; B60W 2552/30; B60W 2540/223; B60W 2540/229; B60W 2420/42; B60W 2552/15; B60R 2022/4866; B60R 2022/4808; G05D 1/0088

(57) ABSTRACT

A method for controlling an autonomous driving operation comprising at least one processor includes determining a predicted driving condition of a vehicle; determining a predicted driving operation of the vehicle based on the predicted driving condition; determining necessity of wearing of a seat belt of a passenger, based on an image of the passenger captured by an interior vision sensor and the predicted driving operation; requesting the passenger to wear the seat belt and determining wearing of a seat belt of the passenger based on the necessity of wearing of a seat belt of the passenger; and controlling a driving operation of the vehicle based on a result obtained by determining the wearing of a seat belt of the passenger. The method of the present disclosure may be performed based on a deep neural network generated through machine learning and an Internet of Things (IoT) environment using a 5G network.

### CROSS-REFERENCE TO RELATED APPLICATION

Pursuant to 35 U.S.C. § 119(a), this application claims the benefit of earlier filing date and right of priority to Korean Patent Application No. 10-2019-0148907, filed on Nov. 19, 2019 in the Republic of Korea, the contents of which are hereby incorporated by reference herein in its entirety into the present application.

### BACKGROUND

### 1. Technical Field

The present disclosure relates to an apparatus and method for controlling a driving operation of an autonomous vehicle.

### 2. Description of Related Art

Various sensors and electronic devices for facilitating control of a driving operation of a driver are installed in a vehicle, and an example thereof is an advanced driver assistance system (ADAS).

Further, an autonomous vehicle controls the driving operation autonomously, communicates with a server to control the driving operation without intervention or manipulation by the driver, or drives autonomously with minimum intervention by the driver to provide convenience to the driver.

An autonomous vehicle is capable of recognizing an environment around a vehicle by using a sensor such as a RADAR, a LIDAR, a camera, an ultrasonic sensor, or a vision sensor and is capable of recognizing the environment around the vehicle and road conditions to automatically control a speed of the vehicle and driving.

A driving operation is determined by a conventional autonomous vehicle based only on the environment around the vehicle and road conditions without considerations of a risk to a passenger.

However, when the autonomous vehicle controls the driving operation of the vehicle, it is necessary to consider the state of the passenger. For example, the autonomous vehicle needs to determine the driving operation for turning while considering a risk to a passenger due to centrifugal force when turning on a curved road.

The autonomous vehicle needs to determine the driving operation while considering a risk to a passenger based on whether the passenger wears a seat belt. For example, if wearing of a seat belt is not compulsory for a passenger in accordance with an autonomous driving level of the autonomous vehicle, a driving operation of the autonomous vehicle needs to be changed in accordance with whether a passenger wears a seat belt.

The above-described background technology is technical information that the inventors have held for the derivation of the present disclosure or that the inventors acquired in the process of deriving the present disclosure. Thus, the above-described background technology cannot be regarded as known technology disclosed to the general public prior to the filing of the present application.

### SUMMARY OF THE INVENTION

An aspect of the present disclosure is to provide a method and apparatus for determining a driving operation of an autonomous vehicle while considering a risk to a passenger.

In addition, another aspect of the present disclosure is to provide a method and apparatus for determining a risk to a passenger due to a driving operation of an autonomous vehicle.

In addition, another aspect of the present disclosure is to provide a method and apparatus for determining a risk to a passenger based on a driving operation predicted on various driving routes.

In addition, another aspect of the present disclosure is to provide a method and apparatus for determining a risk to a passenger due to a driving operation of an autonomous vehicle based on an internal monitoring sensor (IMS) of an autonomous vehicle.

In addition, another aspect of the present disclosure is to provide a method and apparatus for determining whether a passenger wears a seat belt based on an IMS of an autonomous vehicle.

The present disclosure is not limited to what has been described above, and other aspects and advantages of the present disclosure will be understood by the following description and become apparent from the embodiments of the present disclosure. Furthermore, it will be understood that aspects and advantages of the present disclosure may be achieved by the means set forth in claims and combinations thereof.

According to an embodiment of the present disclosure, a method for controlling an autonomous driving operation of a vehicle control apparatus may determine a risk to a passenger according to a predicted driving operation based on a predicted driving condition of a vehicle.

According to another embodiment of the present disclosure, a method for controlling an autonomous driving operation of a vehicle control apparatus may request that a passenger wear a seat belt according to a risk to a passenger and may determine whether the passenger wears the seat belt.

According to another embodiment of the present disclosure, a method for controlling an autonomous driving operation of a vehicle control apparatus may determine a driving operation of reducing a risk to a passenger based on whether a passenger wears a seat belt.

In detail, according to an embodiment of the present disclosure, a method for controlling an autonomous driving operation of a vehicle control apparatus may be a method performed by a vehicle control apparatus including at least one processor and may include determining a predicted driving operation of a vehicle based on a predicted driving condition of the vehicle, determining necessity of wearing of a seat belt of the passenger, based on an image of the passenger and the predicted driving operation of the vehicle, and then controlling a driving operation of the vehicle based on a result obtained by determining whether the passenger wears the seat belt.

In detail, according to an embodiment of the present disclosure, a vehicle control apparatus includes a processor, a vision sensor configured to photograph an interior of a vehicle, a driving device configured to drive the vehicle, and a memory operatively connected to the processor and to store at least one code executed by the processor, wherein the memory stores codes configured to cause the processor to determine a predicted driving operation of the vehicle based on a predicted driving condition of a vehicle; determine necessity of wearing of a seat belt of a passenger and wearing of a seat belt of the passenger based on the image of the passenger, captured by the vision sensor, and the predicted driving operation; and control the driving device based on a result obtained by determining the wearing of a seat belt of the passenger when the code is executed by the processor.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a diagram illustrating an example of an AI system to which an AI device including an autonomous vehicle is connected;

FIG. 2 is a diagram illustrating an example of an environment in which a method for controlling an autonomous driving operation of a vehicle control apparatus, according to the present disclosure, is performed;

FIG. 3 is a diagram illustrating an example of an AI server which is communicable with an autonomous vehicle;

FIG. 4 is a block diagram illustrating an autonomous vehicle according to an embodiment of the present disclosure;

FIG. 5 is a diagram showing an example of the basic operation of an autonomous vehicle and a 5G network in a 5G communication system;

FIG. 6 is a diagram illustrating an example of an applied operation of an autonomous vehicle and a 5G network in a 5G communication system;

FIGS. 7 to 10 are diagrams illustrating an example of the operation of an autonomous vehicle using a 5G communication;

FIG. 11 is a flowchart for explaining a method for controlling an autonomous driving operation of a vehicle control apparatus according to an embodiment of the present disclosure;

FIGS. 12 and 13 are diagrams illustrating an example of a method for controlling an autonomous driving operation of a vehicle control apparatus according to an embodiment of the present disclosure;

FIGS. 14 and 15 are diagrams illustrating an example of a method for determining a risk to a passenger of a vehicle control apparatus according to an embodiment of the present disclosure;

FIG. 16 is a diagram showing an example for explaining a method for determining whether a passenger wears a seat belt by a vehicle control apparatus according to an embodiment of the present disclosure;

FIG. 17 is a diagram showing an example for explaining a method for determining a driving operation for reducing a risk to a passenger by a vehicle control apparatus according to an embodiment of the present disclosure; and

FIG. 18 is a diagram showing an example for explaining a method for controlling an autonomous driving operation of a vehicle control apparatus according to an embodiment of the present disclosure.

### DETAILED DESCRIPTION

The embodiments disclosed in the present specification will be described in greater detail with reference to the accompanying drawings, and throughout the accompanying drawings, the same reference numerals are used to designate the same or similar components and redundant descriptions thereof are omitted. As used herein, the terms “module” and “unit” used to refer to components are used interchangeably in consideration of convenience of explanation, and thus, the terms per se should not be considered as having different meanings or functions. Further, in the description of the embodiments of the present disclosure, when it is determined that the detailed description of the related art would obscure the gist of the present disclosure, the description thereof will be omitted. Further, the accompanying drawings are provided for more understanding of the embodiment disclosed in the present specification, but the technical spirit disclosed in the present disclosure is not limited by the accompanying drawings. It should be understood that all changes, equivalents, and alternatives included in the spirit and the technical scope of the present disclosure are included.

Although the terms first, second, third, and the like may be used herein to describe various elements, components, regions, layers, and/or sections, these elements, components, regions, layers, and/or sections should not be limited by these terms. These terms are generally only used to distinguish one element from another.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present.

As used herein, the singular forms “a,” “an,” and “the” are intended to include the plural forms as well, unless the context clearly indicates otherwise.

It should be understood that the terms “comprises,” “comprising,” “includes,” “including,” “containing,” “has,” “having” or any other variation thereof specify the presence of stated features, integers, steps, operations, elements, and/or components, but do not preclude the presence or addition of one or more other features, integers, steps, operations, elements, and/or components.

A vehicle described herein may refer to an automobile and a motorcycle. Hereinafter, the vehicle will be exemplified as an automobile.

The vehicle described in the present disclosure may include, but is not limited to, a vehicle having an internal combustion engine as a power source, a hybrid vehicle having an engine and an electric motor as a power source, and an electric vehicle having an electric motor as a power source.

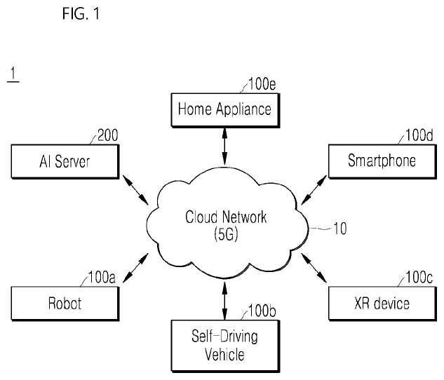

FIG. 1 illustrates an AI system 1 according to an embodiment of the present disclosure.

Referring to FIG. 1, in the AI system 1, at least one or more of AI server 200, robot 100a, autonomous vehicle 100b, XR device 100c, smartphone 100d, or home appliance 100e are connected to a cloud network 10. Here, the robot 100a, autonomous vehicle 100b, XR device 100c, smartphone 100d, or home appliance 100e to which the AI technology has been applied may be referred to as an AI device (100a to 100e).

The cloud network 10 may configure part of the cloud computing infrastructure or refer to a network existing in the cloud computing infrastructure. Here, the cloud network 10 may be constructed by using a 3G network, a 4G or Long Term Evolution (LTE) network, or a 5G network.

In other words, individual devices (100a to 100e, 200) constituting the AI system 1 may be connected to each other through the cloud network 10. In particular, each individual device (100a to 100e, 200) may communicate with each other through a base station, but may also communicate directly to each other without relying on the base station.

The AI server 200 may include a server performing AI processing and a server performing computations on big data.

The AI server 200 may be connected to at least one or more of the robot 100a, autonomous vehicle 100b, XR device 100c, smartphone 100d, or home appliance 100e, which are AI devices constituting the AI system, through the cloud network 10 and may help at least part of AI processing conducted in the connected AI devices (100a to 100e).

Here, the AI server 200 may train the AI network according to a machine learning algorithm instead of the AI devices 100a to 100e, and may directly store a learning model or transmit the learning model to the AI devices 100a to 100e.

Here, the AI server 200 may receive input data from the AI device 100a to 100e, infer a result value from the received input data by using the learning model, generate a response or control command based on the inferred result value, and transmit the generated response or control command to the AI device 100a to 100e.

Similarly, the AI device 100a to 100e may infer a result value from the input data by employing the learning model directly and generate a response or control command based on the inferred result value.

By employing the AI technology, the autonomous vehicle 100b may be implemented as a mobile robot, unmanned ground vehicle, or unmanned aerial vehicle.

The autonomous vehicle 100b may include an autonomous navigation module for controlling its autonomous navigation function, where the autonomous navigation control module may correspond to a software module or a chip which implements the software module in the form of a hardware device. The autonomous navigation control module may be installed inside the autonomous vehicle 100b as a constituting element thereof or may be installed outside the autonomous vehicle 100b as a separate hardware component. In this specification, the autonomous navigation control module may also be referred to as a vehicle control apparatus.

The autonomous vehicle 100b may obtain status information of the autonomous vehicle 100b, detect (recognize) the surroundings and objects, generate map data, determine a driving route and navigation plan, or determine motion by using sensor information obtained from various types of sensors.

Like the robot 100a, the autonomous vehicle 100b may use sensor information obtained from at least one or more sensors among lidar, radar, and camera to determine a driving route and navigation plan.

In particular, the autonomous vehicle 100b may recognize an occluded area or an area extending over a predetermined distance or objects located across the area by collecting sensor information from external devices or receive recognized information directly from the external devices.

The autonomous vehicle 100b may perform the operations above by using a learning model built on at least one or more artificial neural networks. For example, the autonomous vehicle 100b may recognize the surroundings and objects by using the learning model and determine its navigation route by using the recognized surroundings or object information. Here, the learning model may be the one trained by the autonomous vehicle 100b itself or trained by an external device such as the AI server 200.

The autonomous vehicle 100b may generate a result directly using the learning model and perform an operation, but may transmit sensor information ton an external device such as an AI server 200, receive a result generated according thereto, and perform an operation.

The autonomous vehicle 100b may determine a movement path and drive plan by using at least one of object information detected from the map data and sensor information or object information obtained from an external device, and drive according to the determined movement path and drive plan by controlling its driving platform.

Map data may include object identification information about various objects disposed in the space (for example, road) in which the autonomous vehicle 100b navigates. For example, the map data may include object identification information of stationary objects such as streetlamps, rocks, and buildings, and moveable objects such as vehicles and pedestrians. In addition, the object identification information may include a name, a type, a distance to, and a location of the objects.

Also, the autonomous vehicle 100b may perform the operation or navigate the space by controlling its driving platform based on the control/interaction of the user. At this time, the autonomous vehicle 100b may obtain intention information of the interaction due to the user's motion or voice command and perform an operation by determining a response based on the obtained intention information.

By employing the AI and autonomous navigation technologies, the robot 100a may be implemented as a guide robot, transport robot, cleaning robot, wearable robot, entertainment robot, pet robot, or unmanned flying robot.

The robot 100a employing the AI and autonomous navigation technologies may correspond to a robot itself having an autonomous navigation function or a robot 100a interacting with the autonomous navigation function or a robot 11 interacting with the autonomous vehicle 100b.

The robot 100a having the autonomous navigation function may correspond collectively to the devices which may move autonomously along a given path without control of the user or which may move by determining its path autonomously.

The robot 100a and the autonomous vehicle 100b having the autonomous navigation function may use a common sensing method to determine one or more of the driving route or navigation plan. For example, the robot 100a and the autonomous vehicle 100b having the autonomous navigation function may determine one or more of the driving route or navigation plan by using the information sensed through lidar, radar, and camera.

The robot 100a interacting with the autonomous vehicle 100b exists separately from the autonomous vehicle 100b to be connected to the autonomous navigation function inside or outside the autonomous vehicle 100b or perform an operation connected with the user on the autonomous vehicle 100b.

In this case, the robot 100a interacting with the autonomous vehicle 100b obtains sensor information on behalf of the autonomous vehicle to provide the sensor information to the autonomous vehicle 100b or obtains sensor information and generates surrounding environment information or object information to provide the information to the autonomous vehicle 100b, to control or assist the autonomous navigation function of the autonomous vehicle 100b.

In addition, the robot 100a interacting with the autonomous vehicle 100b monitors a user on the autonomous vehicle 100b or interacts with the user to control the function of the autonomous vehicle 100b. For example, if it is determined that the driver is drowsy, the robot 100a may activate the autonomous navigation function of the autonomous vehicle 100b or assist the control of the driving platform of the autonomous vehicle 100b. Here, the function of the autonomous vehicle 100b controlled by the robot 100a may include not only the autonomous navigation function but also the navigation system installed inside the autonomous vehicle 100b or the function provided by the audio system of the autonomous vehicle 100b.

In addition, the robot 100a interacting with the autonomous vehicle 100b may provide information to the autonomous vehicle 100b or assist the function at the outside of the autonomous vehicle 100b. For example, the robot 100a may provide traffic information including traffic sign information to the autonomous vehicle 100b like a smart traffic light or may automatically connect an electric charger to the charging port by interacting with the autonomous vehicle 100b like an automatic electric charger of the electric vehicle.

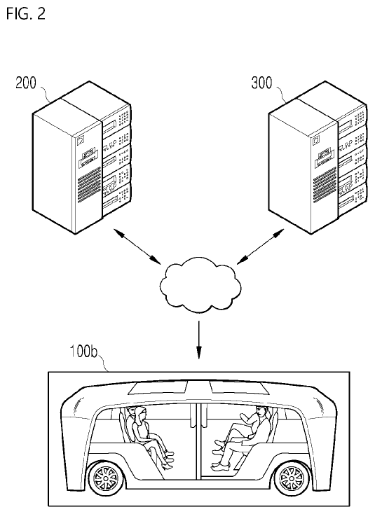

FIG. 2 is a diagram illustrating an example of an environment in which a method for controlling an autonomous driving operation of a vehicle control apparatus according to the present disclosure is performed.

Referring to FIG. 2, the AI server 200 may communicate with the plurality of autonomous vehicles 100b through a network and may determine a driving operation in the autonomous vehicle 100b or may transmit a machine learning-based learning model for determining a risk to a passenger to the autonomous vehicle 100b. In this specification, although the case in which the learning model for determining the risk to the passenger being installed in the autonomous vehicle 100b and the risk to the passenger being determined by the autonomous vehicle 100b are described, the case in which the AI server 200 determines the risk to the passenger based on sensor data received from the autonomous vehicle 100b may not be excluded. Similarly, the autonomous vehicle 100b may determine a driving operation based on the risk to the passenger, but the case in which the AI server 200 determines the driving operation based on the risk to the passenger may not be excluded. That is, the vehicle control apparatus may be implemented as an embodiment of the autonomous vehicle 100b or may be implemented as an embodiment of the AI server 200. In this specification, the vehicle control apparatus is assumed to be implemented as an embodiment of the autonomous vehicle 100b.

The autonomous vehicle 100b or the AI server 200 may communicate with a traffic server 300 to receive information related to, for example, a traffic condition or map information. The traffic condition may include, for example, a road congestion condition, accident information on a driving route, or construction information on a driving route, and the map information may include, for example, geographic information of a road or a road gradient. In addition, the traffic server 300 may also provide environment information such as weather information.

The autonomous vehicle 100b or the AI server 200 may determine a predicted driving route of the autonomous vehicle 100b based on the map information, and the autonomous vehicle 100b may be controlled to be driven based on the predicted driving route.

The autonomous vehicle 100b or the AI server 200 may determine the driving operation based on the traffic condition and the predicted driving route. For example, the autonomous vehicle 100b or the AI server 200 may determine the driving operation to drive a vehicle in a straight path at maximum speed when a road is not congested, or may determine a risk to a passenger according to whether the passenger wears a seat belt and determine the driving operation to drive the vehicle in a straight path at a lower speed than the maximum speed.

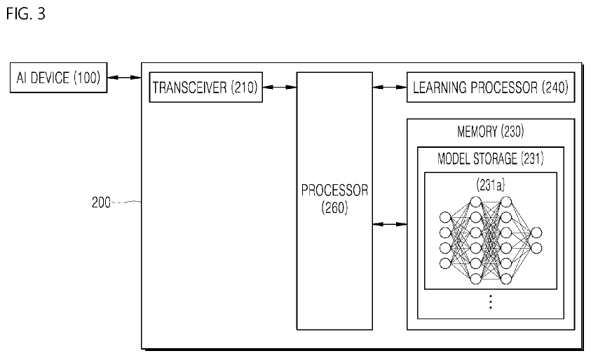

FIG. 3 is a diagram illustrating an example of the AI server 200 with which the autonomous vehicle 100b is capable of communicating.

Referring to FIG. 3, the AI server 200 may refer to a device for training an artificial neural network using a machine learning algorithm or using a trained artificial neural network. Here, the AI server 200 may include a plurality of servers to perform distributed processing, and may be defined as a 5G network. In this case, the AI server 200 may be included as a component of the autonomous vehicle 100b and may also perform at least some of the AI processing along with the autonomous vehicle 100b.

The AI server 200 may include a transceiver 210, a memory 230, a learning processor 240, and a processor 260.

The transceiver 210 may transmit and receive data to and from an external device such as the autonomous vehicle 100b.

The memory 230 may include a model storage 231. The model storage 231 may store a model (or an artificial neural network 231a) that is being trained or has been trained via the learning processor 240.

The learning processor 240 may train the artificial neural network 231a using learning data. A learning model may be used while being installed in the AI server 200 of the artificial neural network or may be used while being installed in an external device such as the autonomous vehicle 100b.

The learning model may be implemented as hardware, software, or a combination of hardware and software. When a portion or the entirety of the learning model is implemented as software, one or more instructions, which constitute the learning model, may be stored in the memory 230.

The processor 260 may infer a result value with respect to new input data using the learning model, and generate a response or control command based on the inferred result value.

The processor 260 may apply the learning model to sensor detection information received from the autonomous vehicle 100b through the transceiver 210 and may evaluate a safety level of a region around the autonomous vehicle 100b.

According to an embodiment, the processor 260 may determine a risk to a passenger based on the data received from the autonomous vehicle 100b and may determine the driving operation of the autonomous vehicle 100b.

The transceiver 210 may transmit data indicating the determined driving operation to the autonomous vehicle 100b.

The memory 230 may store passenger sensing information of an internal monitoring sensor (IMS), received from the autonomous vehicle 100b, and the processor 260 may determine the risk to the passenger based on the passenger sensing information and may determine the driving operation of the autonomous vehicle 100b.

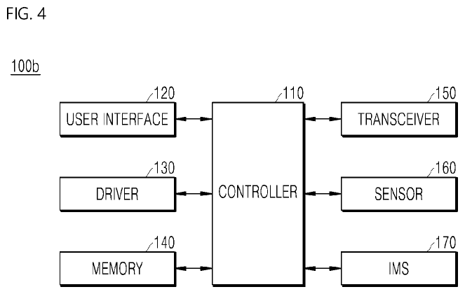

FIG. 4 is a block diagram illustrating the autonomous vehicle 100b according to an embodiment of the present disclosure.

Referring to FIG. 4, the autonomous vehicle 100b, according to an embodiment, may include a user interface 120 for providing notification of, for example, wearing a seat belt or a driving route hazard to a user; a driver 130 for driving the autonomous vehicle 100b; a memory 140 for storing the learning model and the driving route received from the AI server 200 and the traffic information received from the traffic server 300, and for storing commands for controlling the driver 130; a controller 110 for controlling the user interface 120 and the driver 130; the transceiver 150 for receiving the learning model and driving data from the AI server 200, for receiving the map information from the traffic server 300, and for supporting communication between apparatuses inside the autonomous vehicle 100b; a sensor 160 for monitoring an internal and external environment of the autonomous vehicle 100b; and an internal monitoring sensor for monitoring an internal passenger. The internal monitoring sensor may be implemented in the form of a camera 170 according to an embodiment.

The transceiver 150 may transmit and receive data and to and from external apparatuses such as another autonomous vehicle 100b, the AI server 200, or the traffic server 300 using wired and wireless communication technology. For example, the transceiver 150 may transmit and receive sensor information, user input, a learning model, and a control signal to and from the external devices.

In this case, the communications technology used by the communicator 150 may be technology such as global system for mobile communication (GSM), code division multi access (CDMA), long term evolution (LTE), 5G, wireless LAN (WLAN), Wireless-Fidelity (Wi-Fi), Bluetooth™, radio frequency identification (RFID), infrared data association (IrDA), ZigBee, and near field communication (NFC).

The controller 110 and other components may communicate with each other through an internal network of the autonomous vehicle 100b. The internal network of the autonomous vehicle 100b may use a wired or wireless manner. For example, the internal network of the autonomous vehicle 100b may include at least one of controller area network (CAN), universal serial bus (USB), a high definition multimedia interface (HDMI), recommended standard d232 (RS-232), or a plain old telephone service (POTS), an universal asynchronous receiver/transmitter (UART), a local interconnect network (LIN), media oriented systems transport (MOST), Ethernet, FlexRay, and Wi-Fi based network.

The internal network of the autonomous vehicle 100b may include at least one of telecommunications networks, for example, computer networks (for example, LAN or WAN).

The user interface 120 may acquire various types of data.

The user interface 120 may include a camera for inputting an image signal, a microphone for receiving an audio signal, and a user input interface for receiving information inputted from a user. Here, the signal obtained from a camera or a microphone may also be referred to as sensing data or sensor information by regarding the camera or the microphone as a sensor.

The user interface 120 may acquire various kinds of data, such as learning data for model learning and input data used when an output is acquired using a learning model. The user interface 120 may obtain raw input data. In this case, the controller 110 may extract an input feature by preprocessing the input data.

The user interface 120 may generate a visual, auditory, or tactile related output.

In this case, the user interface 120 may include, for example, a display for outputting visual information, a speaker for outputting audible information, or a haptic module for outputting haptic information.

The transceiver 150 may receive driving route data from the AI server 200. According to another embodiment, the transceiver 150 may receive a learning model for determining necessity of wearing of a seat belt based on a risk to a passenger from the AI server 200.

The memory 140 may store the driving route data or the learning model received from the AI server 200.

The memory 140 may store data for supporting various functions of the autonomous vehicle 100b. For example, the memory 140 may store input data, the learning data, the learning model, learning history, or the like, obtained from the user interface 120.

The controller 110 may determine at least one executable operation of the autonomous vehicle 100b based on information determined or generated by using a data analysis algorithm or a machine learning algorithm. In addition, the controller 110 may control components of the autonomous vehicle 100b to perform the determined operation. The determined operation may be the driving operation of the autonomous vehicle 100b.

To this end, the controller 110 may request, search for, receive, or use data of the memory 140 and may control components of the autonomous vehicle 100b to perform a predicted operation among the at least one executable operation or an operation determined to be appropriate.

In this case, when it is required to be linked with the external device to perform the determined operation, the controller 110 generates a control signal for controlling the corresponding external device and transmits the generated control signal to the corresponding external device.

The controller 110 obtains intent information about user input, and may determine a requirement of a user based on the obtained intent information.

In this case, the controller 110 may obtain the intent information corresponding to the user input using at least one of a speech to text (STT) engine for converting a speech input into text strings or a natural language processing (NLP) engine for obtaining intent information of the natural language.

In an embodiment, the at least one of the STT engine or the NLP engine may be composed of artificial neural networks, some of which are trained according to a machine learning algorithm. In addition, the at least one of the STT engine or the NLP engine may be trained by the controller 110, trained by a learning processor 240 of an AI server 200, or trained by distributed processing thereof.

The controller 110 may collect history information including, for example, an operation of the autonomous vehicle 100b or user feedback to the operation, and may store the history information in the memory 140 or may transmit the history information to an external apparatus such as the AI server 200. The collected history information may be used to update a learning model.

The controller 110 may control at least some of the components of the autonomous vehicle 100b in order to drive an application program stored in the memory 140. The controller 110 may combine and operate two or more components included in the autonomous vehicle 100b in order to drive the application program.

The controller 110 may control the driver 130 to drive the autonomous vehicle 100b based on the driving route. The controller 110 may change the driving operation in consideration of a change (for example, existence of other vehicles or obstacles present on a driving route) to a driving environment on the driving route, and may control the driver 130 according to the changed driving operation.

The controller 110 may determine the predicted driving operation of the autonomous vehicle 100b based on the predicted driving condition of the predicted driving route, and may determine the risk to the passenger according to the predicted driving operation based on, for example, shape and posture of a passenger, detected through the internal camera 170. According to an embodiment, the controller 110 may apply the learning model stored in the memory 140 to data extracted from an image of a passenger, captured by the internal camera 170, and may determine the risk to the passenger.

The internal camera 170 may include an RGB sensor camera, or a depth sensor camera such as a time of flight (ToF) sensor.

When determining that a passenger is in danger when the autonomous vehicle 100b performs the predicted driving operation, the controller 110 may request a user to wear a seat belt through the user interface 120.

The controller 110 may determine whether the passenger wears the seat belt based on an operation of the passenger, detected through the internal camera 170, after requesting the user to wear the seat belt. According to an embodiment, the controller 110 may apply the learning model stored in the memory 140 to data extracted from a plurality of images of the passenger, captured by the internal camera 170, and may determine whether the passenger wears the seat belt.

When determining that the passenger does not wear the seat belt after requesting the passenger to wear the seat belt, the controller 110 may change the predicted driving operation based on the risk to the passenger. According to an embodiment, the controller 110 may change the predicted driving operation to reduce the risk to the passenger.

In an embodiment, the controller 110 may be implemented as a learning processor and may train a model configured with an artificial neural network using learning data. Here, the trained artificial neural network may be referred to as a learning model. The trained model may be used to infer a result value with respect to new input data rather than learning data, and the inferred value may be used as a basis for a determination to perform an operation of classifying the detected hand motion.

The controller 110 may perform AI processing together with a learning processor 240 of the AI server 200.

In this case, the controller 110 may include a memory that is integrated into or is implemented in the autonomous vehicle 100b. In addition, the controller 110 may be implemented using the memory 140, an external memory that is directly coupled to the autonomous vehicle 100b, or a memory maintained in an external apparatus.

The sensor 160 may acquire at least one of internal information of the autonomous vehicle 100b, surrounding environment information of the autonomous vehicle 100b, or user information using various sensors.

The sensor 160 may include a proximity sensor, an illumination sensor, an acceleration sensor, a magnetic sensor, a gyroscope sensor, an inertial sensor, an RGB sensor, an infrared (IR) sensor, a finger scan sensor, an ultrasonic sensor, an optical sensor, a microphone, an optical camera, a radar, a light detection and ranging (LiDAR) sensor, or a combination thereof.

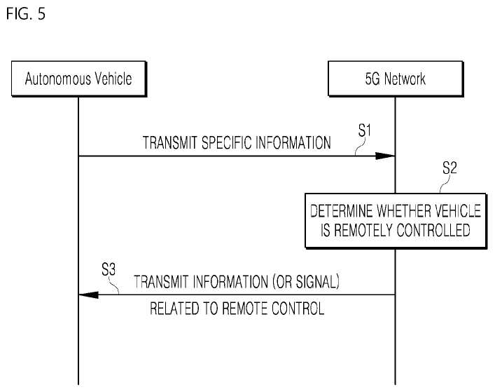

FIG. 5 is a diagram showing an example of the basic operation of an autonomous vehicle and a 5G network in a 5G communication system.

The autonomous vehicle 100b may transmit specific information to the 5G network (S1).

The specific information may include autonomous driving related information.

The autonomous driving related information may be information directly related to the running control of the vehicle. For example, the autonomous driving-related information may include one or more of object data indicating an object around the vehicle, map data, vehicle state data, vehicle location data, and driving plan data.

The autonomous driving related information may further include service information necessary for autonomous driving. For example, the specific information may include information about the destination and the stability level of the vehicle, which are inputted through a user terminal. In addition, the 5G network may determine whether the vehicle is remotely controlled (S2).

Here, the 5G network may include a server or a module that performs autonomous driving related remote control.

The 5G network may transmit information (or signals) related to the remote control to the autonomous vehicle (S3).

As described above, the information related to the remote control may be a signal directly applied to the autonomous vehicle, and may further include service information required for autonomous driving. In one embodiment of the present disclosure, the autonomous vehicle can provide autonomous driving related services by receiving service information such as danger sector information selected on a route through a server connected to the 5G network.

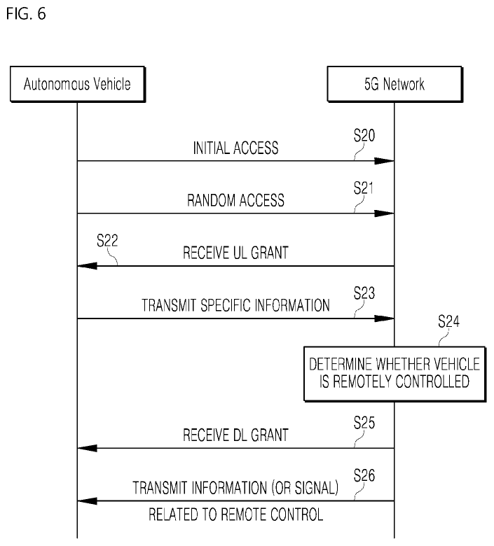

Hereinafter, FIGS. 6 to 10 schematically illustrate an essential process for 5G communication between an autonomous vehicle and a 5G network (for example, an initial access procedure between the vehicle and the 5G network, etc.) in order to receive data related to driving route during the autonomous driving according to one embodiment of the present disclosure.

FIG. 6 illustrates an example of an application operation of the autonomous vehicle 100b and a 5G network in a 5G communication system.

The autonomous vehicle 100b may perform an initial access procedure on the 5G network (S20).

The initial access procedure includes a process of acquiring a cell AI server 200 (cell search) and system information for downlink (DL) operation acquisition.

In addition, the autonomous vehicle 100b may perform a random access process on the 5G network (S21).

The random access process may include a process for uplink (UL) synchronization acquisition or a preamble transmission process for UL data transmission, or a random access response receiving process, which will be described in detail in the paragraph G.

In addition, the 5G network may transmit UL grant for scheduling transmission of the specific information to the autonomous vehicle 100b (S22).

The UL grant reception includes a scheduling process of time/frequency resource for transmission of the UL data over the 5G network.

In addition, the autonomous vehicle 100b may transmit the specific information to the 5G network based on the UL grant (S23).

In addition, the 5G network determines whether the vehicle is to be remotely controlled (S24).

In addition, the autonomous vehicle 100b receives the DL grant through a physical downlink control channel for receiving a response to specific information from the 5G network (S25).

In addition, the 5G network may transmit information (or a signal) related to the remote control to the autonomous vehicle based on the DL grant (S26).

In the meantime, although in FIG. 6, an example in which the initial access process or the random access process of the autonomous vehicle and 5G communication and the downlink grant reception process are combined has been exemplarily described through the steps S20 to S26, the present disclosure is not limited thereto.

For example, the initial access process and/or the random access process may be performed through S20, S22, S23, S24, and S25. Further, for example, the initial access process and/or the random access process may be performed through S21, S22, S23, S24, and S26. Further, a process of combining the AI operation and the downlink grant receiving process may be performed through S23, S24, S25, and S26.

Further, in FIG. 6, the operation of the autonomous vehicle has been illustratively described through S20 to S26, but the present disclosure is not limited thereto.

For example, the operation of the autonomous vehicle may be performed by selectively combining the steps S20, S21, S22, and S25 with the steps S23 and S26. Further, for example, the operation of the autonomous vehicle may be configured by the steps S21, S22, S23, and S26. Further, for example, the operation of the autonomous vehicle may be configured by the steps S20, S21, S23, and S26. Further, for example, the operation of the autonomous vehicle may be configured by the steps S22, S23, S25, and S26.

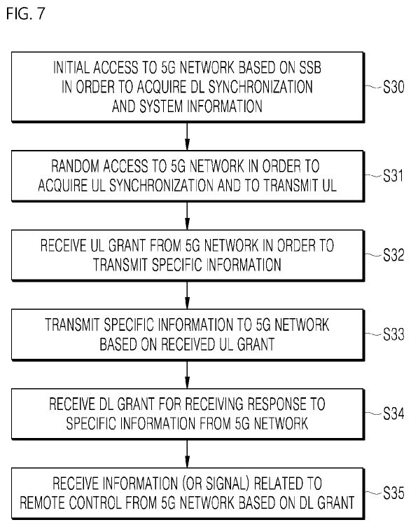

FIGS. 7 to 10 illustrate an example of an operation of an autonomous vehicle 100b using 5G communication.

First, referring to FIG. 7, the autonomous vehicle 100b including an autonomous driving module performs an initial access procedure with a 5G network based on a synchronization signal block (SSB) in order to acquire DL synchronization and system information (S30).

In addition, the autonomous vehicle 100b performs a random access procedure with the 5G network for UL synchronization acquisition and/or UL transmission (S31).

In addition, the autonomous vehicle 100b may receive the UL grant from the 5G network in order to transmit the specific information (S32).

In addition, the autonomous vehicle 100b may transmit the specific information to the 5G network based on the UL grant (S33).

In addition, the autonomous vehicle 100b may receive DL grant for receiving the response to the specific information from the 5G network (S34).

In addition, the autonomous vehicle 100b may receive remote control related information (or a signal) from the 5G network based on the DL grant (S35).

Beam Management (BM) may be added to step S30, a beam failure recovery process associated with Physical Random Access Channel (PRACH) transmission may be added to step S31, a QCL (Quasi Co-Located) relation may be added to step S32 with respect to a beam receiving direction of a Physical Downlink Control Channel (PDCCH) including an UL grant, and a QCL relation may be added to step S33 with respect to the beam transmission direction of the Physical Uplink Control Channel (PUCCH)/Physical Uplink Shared Channel (PUSCH) including specific information. Further, the QCL relation may be added to step S34 with respect to the beam receiving direction of PDCCH including a DL grant.

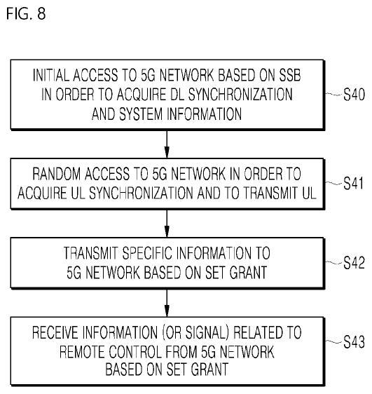

Referring to FIG. 8, the autonomous vehicle 100b performs the initial access procedure with the 5G network based on the SSB in order to acquire the DL synchronization and system information (S40).

In addition, the autonomous vehicle 100b performs a random access procedure with the 5G network for UL synchronization acquisition and/or UL transmission (S41).

In addition, the autonomous vehicle 100b may transmit the specific information to the 5G network based on a configured grant (S42). A process of transmitting the configured grant, instead of the process of receiving the UL grant from the 5G network, will be described in more detail in the paragraph H.

In addition, the autonomous vehicle 100b receives remote control related information (or signal) from the 5G network based on the configured grant (S43).

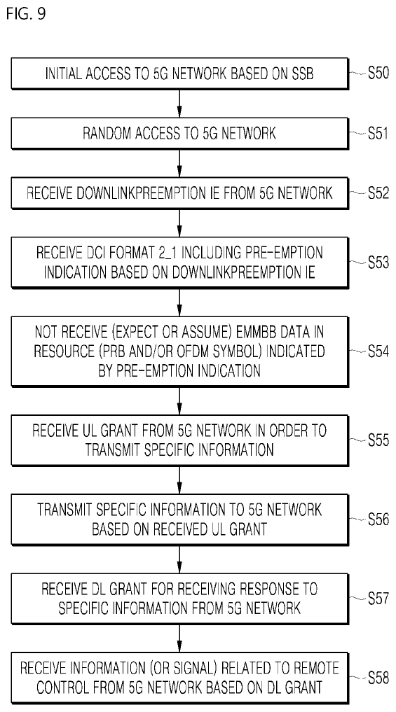

Referring to FIG. 9, the autonomous vehicle 100b performs the initial access procedure with the 5G network based on the SSB in order to acquire the DL synchronization and system information (S50).

In addition, the autonomous vehicle 100b performs a random access procedure with the 5G network for UL synchronization acquisition and/or UL transmission (S51).

In addition, the autonomous vehicle 100b may receive DownlinkPreemption IE from the 5G network (S52).

In addition, the autonomous vehicle 100b receives a DCI (Downlink Control Information) format 2_1 including pre-emption indication based on the DL preemption IE from the 5G network (S53).

In addition, the autonomous vehicle does not perform (or expect or assume) the reception of eMBB data in the resource (PRB and/or OFDM symbol) indicated by the pre-emption indication (S54).

The pre-emption indication related operation will be described in more detail in the paragraph J.

In addition, the autonomous vehicle 100b may receive UL grant to the SG network in order to transmit specific information (S55).

In addition, the autonomous vehicle 100b may transmit the specific information to the 5G network based on the UL grant (S56).

In addition, the autonomous vehicle 100b may receive DL grant for receiving a response to the specific information from the 5G network (S57).

In addition, the autonomous vehicle 100b may receive information (or a signal) related to remote control from the 5G network based on the DL grant (S58).

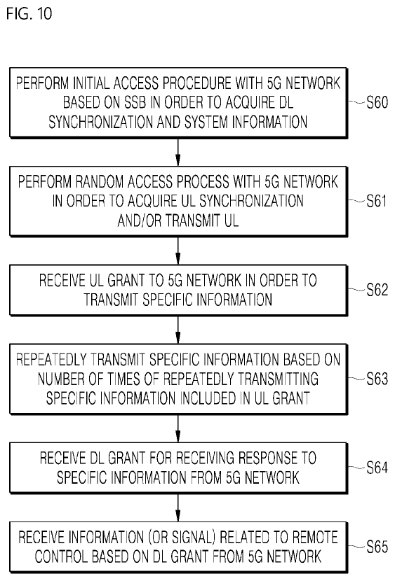

Referring to FIG. 10, the autonomous vehicle 100b performs the initial access procedure with the 5G network based on the SSB in order to acquire the DL synchronization and system information (S60).

In addition, the autonomous vehicle 100b performs a random access procedure with the 5G network for UL synchronization acquisition and/or UL transmission (S61).

In addition, the autonomous vehicle 100b may receive UL grant from the 5G network in order to transmit the specific information (S62).

The UL grant includes information on the number of repetitions for transmission of the specific information, and the specific information may be repeatedly transmitted based on information on the number of repetitions (S63).

In addition, the autonomous vehicle 100b may transmit the specific information to the 5G network based on the UL grant.

Also, the repetitive transmission of specific information may be performed through frequency hopping, the first specific information may be transmitted in the first frequency resource, and the second specific information may be transmitted in the second frequency resource.

The specific information may be transmitted through Narrowband of Resource Block (6RB) and Resource Block (1RB).

In addition, the autonomous vehicle 100b may receive the DL grant for receiving a response to the specific information from the 5G network (S64).

In addition, the autonomous vehicle 100b may receive information (or a signal) related to remote control from the 5G network based on the DL grant (S65).

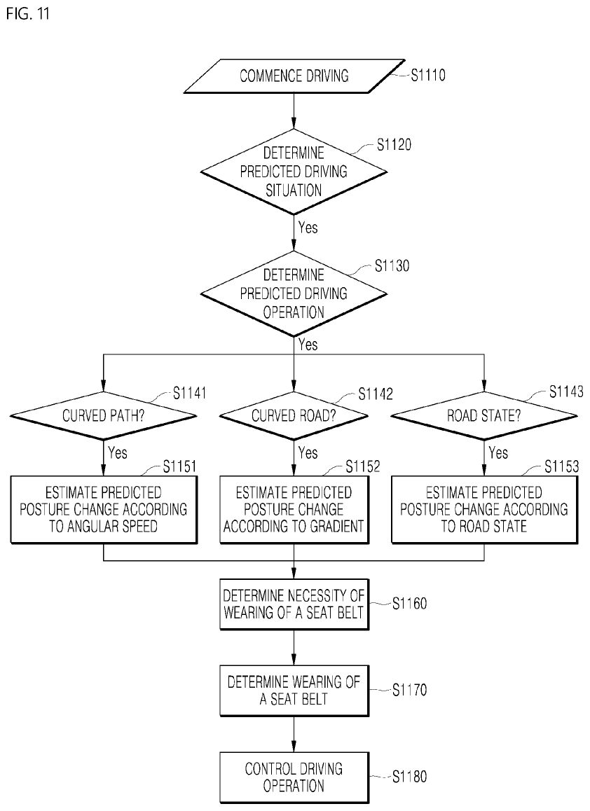

The above-described 5G communication technique can be applied in combination with the methods proposed in this specification, which will be described in FIG. 11 to FIG. 18, or supplemented to specify or clarify the technical feature of the methods proposed in this specification.

A vehicle described in this specification may be connected to an external server through a communication network and may be moved along a preset route without intervention of a driver or with some intervention of the driver using autonomous navigation technologies. The vehicle described herein may include, but is not limited to, a vehicle having an internal combustion engine as a power source, a hybrid vehicle having an engine and an electric motor as a power source, and an electric vehicle having an electric motor as a power source.

While the vehicle is driving in the autonomous driving mode, the type and frequency of accident occurrence may depend on the capability of the vehicle of sensing dangerous elements in the vicinity in real time. The route to the destination may include sectors having different levels of risk due to various causes such as weather, terrain characteristics, and traffic congestion.

At least one among an autonomous vehicle 100b, an AI server 200, and a traffic server 300 according to embodiments of the present disclosure may be associated or integrated with, for example, an artificial intelligence module, a drone (unmanned aerial vehicle (UAV)), a robot, an augmented reality (AR) device, a virtual reality (VR) device, and a 5G service related device.

Artificial intelligence refers to a field of studying artificial intelligence or a methodology for creating the same. Moreover, machine learning refers to a field of defining various problems dealing in an artificial intelligence field and studying methodologies for solving the same. In addition, machine learning may be defined as an algorithm for improving performance with respect to a task through repeated experience with respect to the task.

An artificial neural network (ANN) is a model used in machine learning, and may refer in general to a model with problem-solving abilities, composed of artificial neurons (nodes) forming a network by a connection of synapses. The ANN may be defined by a connection pattern between neurons on different layers, a learning process for updating model parameters, and an activation function for generating an output value.

The artificial neural network may include an input layer, an output layer, and optionally one or more hidden layers. Each layer includes one or more neurons, and the artificial neural network may include synapses that connect the neurons to one another. In an ANN, each neuron may output a function value of an activation function with respect to the input signals inputted through a synapse, weight, and bias.

A model parameter refers to a parameter determined through learning, and may include weight of synapse connection, bias of a neuron, and the like. Moreover, hyperparameters refer to parameters which are set before learning in a machine learning algorithm, and include a learning rate, a number of iterations, a mini-batch size, an initialization function, and the like.

The objective of training an artificial neural network is to determine a model parameter for significantly reducing a loss function. The loss function may be used as an indicator for determining an optimal model parameter in a learning process of an artificial neural network.

The machine learning may be classified into supervised learning, unsupervised learning, and reinforcement learning depending on the learning method.

Supervised learning may refer to a method for training the artificial neural network with training data that has been given a label. In addition, the label may refer to a target answer (or a result value) to be inferred by the artificial neural network when the training data is inputted to the artificial neural network. Unsupervised learning may refer to a method for training an artificial neural network using training data that has not been given a label. Reinforcement learning may refer to a learning method for training an agent defined within an environment to select an action or an action order for maximizing cumulative rewards in each state.

Machine learning of an artificial neural network implemented as a deep neural network (DNN) including a plurality of hidden layers may be referred to as deep learning, and the deep learning is one machine learning technique. Hereinafter, the meaning of machine learning includes deep learning.

FIG. 11 is a flowchart for explaining a method for controlling a vehicle driving operation of a vehicle control apparatus implemented in the autonomous vehicle 100b or the AI server 200 according to an embodiment of the present disclosure. Hereinafter, a description of the common parts previously described with reference to FIGS. 1 to 10 will be omitted.

The vehicle control apparatus may order the autonomous vehicle 100b to commence driving according to the driving route determined by the autonomous vehicle 100b or the driving route determined by the traffic server 300 based on the map information and traffic condition received from the traffic server 300 (S1110).

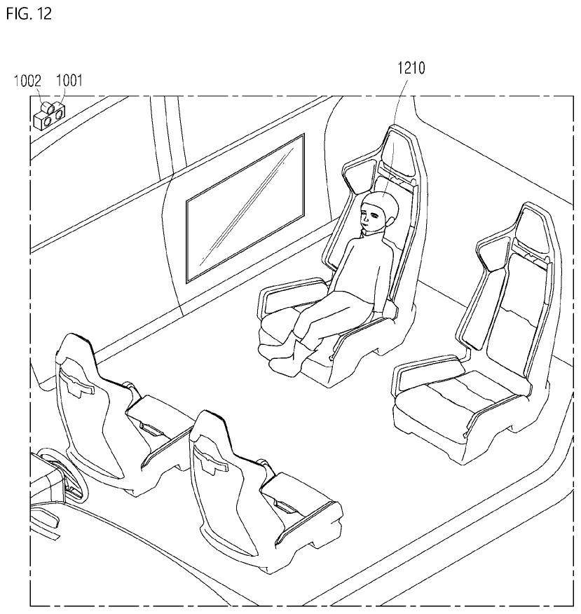

Referring to FIG. 12, the vehicle control apparatus may monitor shape and posture of a passenger 1210 through the internal camera 170 after instructing the driving to commence. For example, the vehicle control apparatus may compare the shape and posture of the passenger 1210, which are determined from an image captured by the internal camera 170, with an internal structure of the autonomous vehicle 100b and may determine that the foot of the passenger 1210 reaches a bottom surface. In addition, the vehicle control apparatus may determine that the passenger 1210 does not wear the seat belt from a front image of the passenger 1210. The internal camera 170 may include a RGB sensor camera 1002 or a depth sensor camera 1001. The RGB sensor camera 1002 may be a stereo vision camera.

The vehicle control apparatus may determine a predicted driving condition based on the driving route (S1120).

The vehicle control apparatus may check the current and future predicted driving route of the autonomous vehicle 100b based on map data that is received based on downward grant of a 5G network from the traffic server 300.

In an embodiment, the checking the predicted driving route may include checking the predicted driving route on which the driving operation of the autonomous vehicle 100b needs to be changed. For example, when the autonomous vehicle 100b travels on a straight path and a driving route that is predicted after a predetermined time elapses is a curved path in the map data, the driving operation of the autonomous vehicle 100b may need to be changed from driving straight to a turn.

In another embodiment, the checking the predicted driving route may include checking the predicted driving route formed by changing the shape of the driving route of the autonomous vehicle 100b. For example, when the autonomous vehicle 100b travels on a straight path, it may be checked whether a driving route formed by changing the current straight path among future driving routes is present in the map data.

The vehicle control apparatus may determine the predicted driving operation of the autonomous vehicle 100b based on the predicted driving condition (S1130).

The vehicle control apparatus may determine the predicted driving operation required to drive on the predicted driving route of the autonomous vehicle 100b.

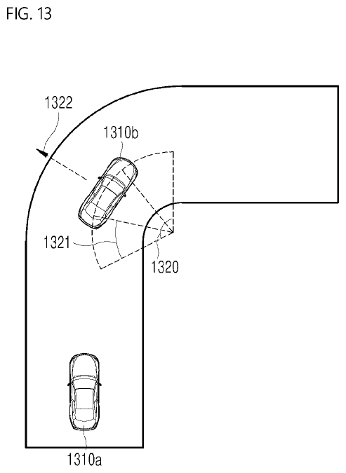

According to an embodiment, referring to FIG. 13, the vehicle control apparatus may check whether the predicted driving route is a curved path 1320 (S1141) and the autonomous vehicle 100b may determine the driving operation required to drive on the curved path 1320.

For example, the vehicle control apparatus may determine that the autonomous vehicle 100b is positioned at a position 1310b on the curved path 1320 after a predetermined time elapses from a current time at which the autonomous vehicle 100b is positioned at a position 1310a based on the map data and the driving route, and may calculate a driving speed of the autonomous vehicle 100b and an angular speed 1321 for a turn, which are required to travel on the curved path 1320. The driving speed for travel on the curved path may be a maximum turning speed at which the autonomous vehicle 100b is capable of traveling or a turning speed calculated using a preset method.

The vehicle control apparatus may determine whether the passenger 1210 needs to wear the seat belt when the autonomous vehicle 100b performs the predicted driving operation (S1160).

In an embodiment, the vehicle control apparatus may estimate a predicted change in the shape or posture of the passenger 1210 based on the shape and posture of the passenger which are determined from an image of the passenger 1210, captured by the internal camera 170, when the autonomous vehicle 100b performs the predicted driving operation.

For example, the vehicle control apparatus may apply a physical condition (which includes, for example, a height or a weight) of the passenger 1210, extracted from an image captured by the internal camera 170, to a physical model using a S/W method based on a posture change of a plurality of passengers having various physical conditions during a turn of the autonomous vehicle 100b at various angular speeds and may estimate a predicted posture change of the passenger 1210. As another method, the vehicle control apparatus may apply an operation algorithm of a humanoid robot to a physical model of the passenger 1210 extracted from an image captured by the internal camera 170 and may estimate a predicted posture change of the passenger 1210.

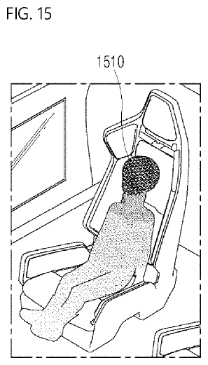

Referring to FIG. 15, the vehicle control apparatus may apply a machine learning-based learning model to an image of the passenger 1210, captured by the RGB sensor camera 1002, and may estimate a densepose 1510 of the passenger 1210 and estimate a predicted posture change of the passenger 1210 during the predicted driving operation of the autonomous vehicle 100b based on the densepose of the passenger. The vehicle control apparatus may apply a 3D physical model to the estimated densepose or may apply an operation algorithm of a humanoid robot and may estimate the predicted posture change of the passenger 1210. The learning model for estimating the densepose may be a deep learning-based learning model as a learning model for mapping a 2D image of a passenger to a 3D surface model of the passenger and may structurally include a region-based model and full convolutional networks.

In another embodiment, the vehicle control apparatus may apply a machine learning-based learning model to an image of the passenger 1210, captured by the depth sensor camera 1001, may perform instance segmentation corresponding to the passenger 1210, and may estimate a predicted posture change of the passenger 1210 during a predicted driving operation of the autonomous vehicle 100b based on the instance segmentation. The vehicle control apparatus may apply a 3D physical model to a result of the instance segmentation or may apply an operation algorithm of a humanoid robot and may estimate the predicted posture change of the passenger 1210. In an embodiment, the learning model for performing the instance segmentation may be a deep learning-based learning model using a mask RCNN method. As a method according to another embodiment, based on a learning model, an image may be segmented into multi resolutions in pre-processing and post-processing processes, each eigenvector may be extracted from the segmented multi resolutions to form a segmentation map, and the results may be synthesized.

The 3D physical model may be a skinned multi-person linear mode (SMPL) model, a Frankenstein model, or an Adam model as a surface-based model.

In an embodiment, when the vehicle control apparatus predicts that the autonomous vehicle 100b will turn on a curved path, the vehicle control apparatus may estimate the possibility that the foot of the passenger 1210 reaches a bottom surface during a turn (S1151). When estimating that the foot of the passenger 1210 reaches the bottom surface during a turn at the calculated angular speed of the autonomous vehicle 100b, the vehicle control apparatus may determine that the passenger 1210 is capable of enduring centrifugal force 1322 due to a turn at the calculated angular speed. Thus, when the vehicle control apparatus determines that the risk to the passenger 1210 is low during a turn at the calculated angular speed and the passenger 1210 does not wear a seat belt, the vehicle control apparatus may also control the driver 130 to perform the turn at the calculated angular speed.

In contrast, when estimating that the foot of the passenger 1210 reaches a bottom surface during a turn at the calculated angular speed of the autonomous vehicle 100b (S1151), the vehicle control apparatus may determine that the risk to the passenger 1210 is high during a turn at the calculated angular speed (S1160) and may ask the passenger 1210 to wear the seat belt through the user interface 120.

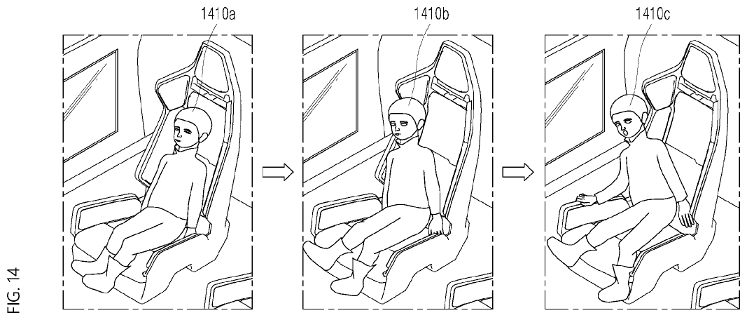

In another embodiment, referring to FIG. 14, when the vehicle control apparatus predicts that the autonomous vehicle 100b will turn on a curved path (S1141), the vehicle control apparatus may estimate a predicted falling angle of the passenger 1210 or a current sleeping state of the passenger during the turn (S1151). When the vehicle control apparatus estimates that predicted falling angles 1410b and 1410c of the passenger 1210 exceeds a preset degree during a turn at the calculated angular speed or that the passenger 1210 sleeps in an image captured by the internal camera 170, the vehicle control apparatus may determine that the risk to the passenger 1210 is high (S1160) and may request the passenger 1210 to wear a seat belt through the user interface 120.

In another embodiment, when the vehicle control apparatus determines that the estimated predicted posture of the passenger 1210 will cause a collision with an internal structure of the autonomous vehicle 100b during the predicted driving operation of the autonomous vehicle 100b, the vehicle control apparatus may determine that the risk to the passenger 1210 is high and may request the passenger 1210 to wear a seat belt through the user interface 120.

When determining that the risk to the passenger 1210 is high, the vehicle control apparatus may request to the passenger 1210 to wear a seat belt through the user interface 120 and may determine whether the passenger 1210 wears the seat belt based on an image captured by the internal camera 170.

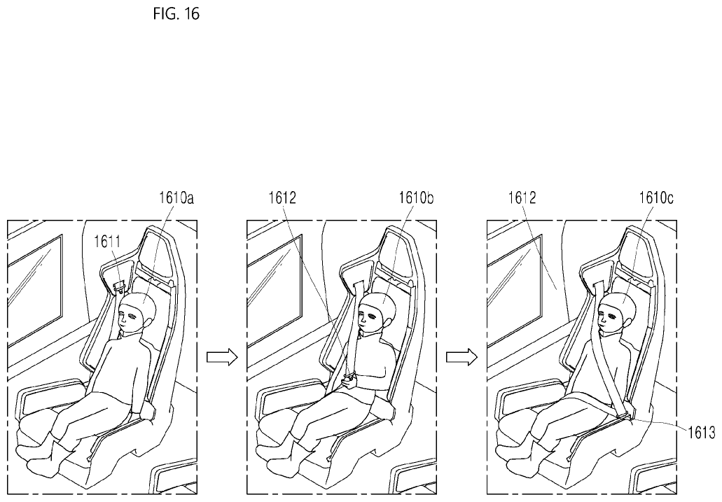

In an embodiment, referring to FIG. 16, after requesting the passenger 1210 to wear a seat belt, the vehicle control apparatus may extract data for determining wearing of a seat belt including positions of hands of passengers 1610a, 1610b, and 1610c, a shape of a seat belt, and positions 1611, 1612, and 1613 of seat belt buckles from a plurality of images captured by the internal camera 170 and may apply a machine learning-based learning model to the data for determining wearing of a seat belt to estimate a final wearing of a seat belt of the passenger (S1170).

The learning model for estimating an action of wearing a seat belt of a passenger may be a learning model trained to estimate the action of wearing the seat belt of the passenger based on learning data including a hand position, a shape of a seat belt, and a position of a seat belt buckle, extracted from a plurality of images captured by photographing a front side of a passenger at different time points via the internal camera 170.

Alternatively, the vehicle control apparatus may estimate the final wearing of a seat belt of a passenger using an image processing method based on a linear shape of a seat belt at a front side of a body of the passenger and a position of a seat belt buckle.

Alternatively, the vehicle control apparatus may apply a machine learning-based learning model to an image of a passenger, captured by the internal camera 170, to estimate keypoint detection of a body part of the passengers 1610a, 1610b, and 1610c, and may compare a posture estimated from the keypoint detection with a seat belt line to estimate the final wearing of a seat belt of the passenger. The machine learning-based learning model may be a deep learning-based learning model including a convolution layer and a pooling layer and may estimate a skeleton obtained by analyzing a seat belt line, a physical keypoint of the passenger, and a keypoint using an image of a plurality of passengers, captured by the internal camera 170, as learning data.

The vehicle control apparatus may determine whether the predicted driving operation required for the predicted driving route is performed without changes or the predicted driving operation is changed according to whether the passenger 1210 wears the seat belt.

For example, when estimating that the passenger 1210 wears the seat belt, the vehicle control apparatus may control the driving operation of the autonomous vehicle 100b at a driving speed of the autonomous vehicle 100b required for a turn on the predicted driving route that is a curved path (S1180).

Alternatively, when estimating that the passenger 1210 does not wear the seat belt, the vehicle control apparatus may control the driving operation of the autonomous vehicle 100b to change the calculated driving speed and to drive the autonomous vehicle 100b at the changed driving speed in order to turn on the predicted driving route that is a curved path (S1180).

In this case, the vehicle control apparatus may change the predicted driving operation to a driving operation for reducing a degree of change of a predicted posture change of the passenger 1210 according to the predicted driving route.

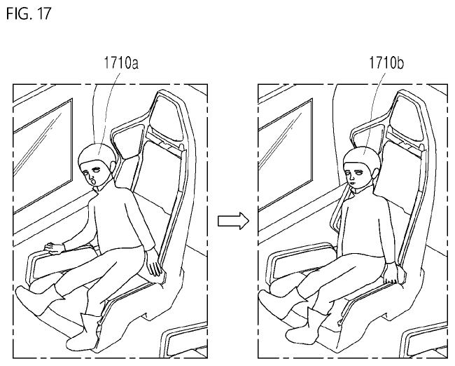

In an embodiment, referring to FIG. 17, even though the vehicle control apparatus determines that a risk of a predicted posture of a passenger 1710a is high at the driving speed of the autonomous vehicle 100b calculated for a turn on the predicted driving route that is a curved path and a seat belt needs to be worn, when the vehicle control apparatus estimates that the passenger does not wear the seat belt, the vehicle control apparatus may control the driving operation of the autonomous vehicle 100b to drive on the curved path via a driving operation with the reduced driving speed. The vehicle control apparatus may control the driving operation of the autonomous vehicle 100b based on a driving speed that corresponds to a degree at which the risk of a predicted posture of a passenger 1710b is low and wearing a seat belt is not required.

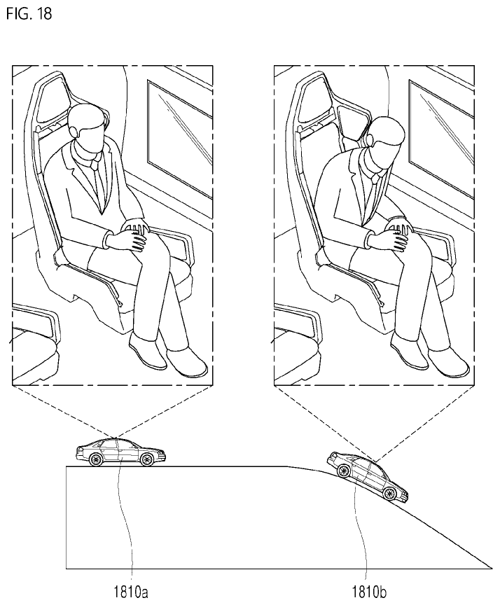

With reference to FIG. 18, an embodiment in which a vehicle control apparatus determines necessity of wearing of a seat belt of a passenger based on a predicted posture change of the passenger depending on an inclination degree on a predicted driving route that is an inclined road will be described.

In an embodiment, the vehicle control apparatus may check whether the predicted driving route is an inclined road (S1142) and may determine a driving operation required for the autonomous vehicle 100b to drive on the inclined road.

For example, the vehicle control apparatus may determine that the autonomous vehicle 100b is positioned on an inclined road 1810b after a predetermined time elapses from a current time at which the autonomous vehicle 100b is positioned at a position 1810a based on the map data and the driving route, and may calculate a driving angle of the autonomous vehicle 100b or deceleration of the predicted driving speed, required for driving on the inclined road. The driving speed for driving on the inclined road may be a driving speed calculated using a preset method. The vehicle control apparatus may determine whether the passenger needs to wear a seat belt based on the predicted posture change of the passenger during the driving operation of the autonomous vehicle 100b based on the driving angle (gradient) and deceleration on the inclination road (S1160). The vehicle control apparatus may determine that the risk is high and may request the passenger to wear a seat belt when a predicted posture of the passenger is inclined to exceed a preset degree on an inclined road. Then, when estimating that the passenger does not wear the seat belt, the vehicle control apparatus may change the predicted driving operation to a driving operation of reducing the calculated deceleration and may control the driving operation of the autonomous vehicle 100b to drive at the reduced deceleration.

In another embodiment, the vehicle control apparatus may check a road state of the predicted driving route (S1143) and may determine a required driving operation of the autonomous vehicle 100b to drive in the road state.

For example, the vehicle control apparatus may determine that the autonomous vehicle 100b passes over a speed bump after a predetermined time elapses at a current position of the autonomous vehicle 100b based on map data, external sensor data, and a driving route, or may determine a reduction in a driving speed due to traffic congestion (S1143). The vehicle control apparatus may calculate a predicted driving speed of the autonomous vehicle 100b, required for passing over the speed bump, or a deceleration of the predicted driving speed due to traffic congestion. The vehicle control apparatus may determine that the risk is very high and may request the passenger to wear a seat belt when the predicted posture of the passenger is inclined to exceed a preset degree while the autonomous vehicle 100b performs the driving operation based on the deceleration. Then, when estimating that the passenger does not wear the seat belt, the vehicle control apparatus may change the predicted driving operation to a driving operation of reducing the calculated deceleration and may control the driving operation of the autonomous vehicle 100b at the reduced deceleration.

The method and apparatus for controlling a driving operation of an autonomous vehicle according to the embodiments of the present disclosure may enhance the safety of a passenger.

In addition, the method and apparatus for controlling a driving operation of an autonomous vehicle according to the embodiments of the present disclosure may determine a driving operation based on whether a passenger wears a seat belt, thereby reducing inconvenience to the passenger.

In addition, the method and apparatus for controlling a driving operation of an autonomous vehicle according to the embodiments of the present disclosure may determine a risk to a passenger during a driving operation according to a type of the passenger.

The effects of the present disclosure are not limited to those mentioned above, and other effects not mentioned can be clearly understood by those skilled in the art from the following description.

The present disclosure described above can be embodied as computer-readable codes on a medium on which a program is recorded. The computer-readable medium may include all kinds of recording devices in which computer-readable data is stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device, etc. In addition, the computer may include the processor of the autonomous vehicle.

The computer programs may be those specially designed and constructed for the purposes of the present disclosure or they may be of the kind well known and available to those skilled in the computer software arts. Examples of computer programs may include both machine codes, such as produced by a compiler, and higher-level codes that may be executed by the computer using an interpreter.

As used in the present disclosure (especially in the appended claims), the terms “a/an” and “the” include both singular and plural references, unless the context clearly states otherwise. Also, it should be understood that any numerical range recited in the present disclosure is intended to include all sub-ranges subsumed therein (unless expressly indicated otherwise) and accordingly, the disclosed numeral ranges include every individual value between the minimum and maximum values of the numeral ranges.

The steps constituting the method according to the present disclosure may be performed in an appropriate order unless a specific order is described or otherwise specified. That is, the present disclosure is not necessarily limited to the order in which the steps are recited. All examples described in the present disclosure or the terms indicative thereof (“for example”, “such as”) are merely to describe the present disclosure in greater detail. Therefore, it should be understood that the scope of the present disclosure is not limited to the example embodiments described above or by the use of such terms unless limited by the appended claims. Also, it should be apparent to those skilled in the art that various modifications, combinations, and alternations may be made depending on design conditions and form factors within the scope of the appended claims or equivalents thereof.

The present disclosure is thus not limited to the example embodiments described above, and rather intended to include the following appended claims, and all modifications, equivalents, and alternatives falling within the spirit and scope of the following claims.

What is claimed is:

1. A method for controlling an autonomous driving operation performed by a vehicle control apparatus including at least one processor, the method comprising:
determining a predicted driving condition of a vehicle;
determining a predicted driving operation of the vehicle based on the predicted driving condition;
determining necessity of wearing of a seat belt of a passenger, based on an image of a passenger captured by an interior vision sensor and the predicted driving operation;
requesting the passenger to wear the seat belt;
determining the wearing of a seat belt of the passenger based on the necessity of the wearing of a seat belt of the passenger; and
controlling a driving operation of the vehicle based on a result obtained by determining the wearing of a seat belt of the passenger.

2. The method of claim 1,
wherein the determining the predicted driving condition comprises checking map data and checking a predicted driving route of the vehicle, based on the map data, and
wherein the determining the predicted driving operation of the vehicle comprises determining the predicted driving operation of the vehicle based on the predicted driving route.

3. The method of claim 2,
wherein the determining the predicted driving operation of the vehicle based on the predicted driving route comprises checking whether the predicted driving route is a curved path and determining a predicted angular speed of the vehicle on the curved path, and
wherein the determining the necessity of the wearing of a seat belt of the passenger comprises estimating a predicted posture change of the passenger depending on the predicted angular speed.

4. The method of claim 3, wherein the estimating the predicted posture change of the passenger comprises:
estimating a predicted situation of the passenger including at least one of a possibility that, on the curved path, a foot of the passenger reaches a bottom surface, a predicted falling angle of the passenger on the curved path, or a current sleeping state of the passenger, based on an image captured by photographing at least a portion of the body of the passenger by the interior vision sensor; and
determining the necessity of the wearing of a seat belt of the passenger based on the predicted situation of the passenger.

5. The method of claim 2,
wherein the determining the predicted driving operation of the vehicle based on the predicted driving route comprises checking the predicted driving route of the vehicle and checking a gradient of the predicted driving route, and
wherein the determining the necessity of the wearing of a seat belt of the passenger comprises estimating a predicted posture change of the passenger depending on the gradient.

6. The method of claim 1, wherein the controlling the driving operation of the vehicle comprises:
changing the predicted driving operation of the vehicle in response to a result, obtained by determining the wearing of a seat belt of the passenger, indicating that the seat belt is not worn; and
controlling the driving operation based on the changed predicted driving operation.

7. The method of claim 6, wherein the changing the predicted driving operation comprises changing the predicted driving operation to a driving operation for reducing a degree of change of a predicted posture change of the passenger according to the predicted driving route.

8. The method of claim 1, wherein the determining the wearing of a seat belt of the passenger comprises:
extracting data for determining the wearing of a seat belt including a position of a hand of the passenger, a shape of the seat belt, and a position of a seat belt buckle from a plurality of images captured by the interior vision sensor after requesting the passenger to wear the seat belt; and
estimating a final wearing of a seat belt of the passenger by applying a first learning model based on machine learning to the data for determining wearing of a seat belt.

9. The method of claim 1,
wherein the determining the predicted driving condition comprises determining a road state of a driving route based on map data or a sensor installed in the vehicle,
wherein the determining the predicted driving operation comprises determining a predicted deceleration based on the road state and a current speed of the vehicle, and
wherein the determining the necessity of the wearing of a seat belt of the passenger comprises estimating a predicted posture change of the passenger based on the predicted deceleration.

10. The method of claim 1, wherein the determining the necessity of the wearing of a seat belt of the passenger comprises:
estimating densepose of the passenger by applying a second learning model based on machine learning to an image captured by photographing at least a portion of the body of the passenger by the interior vision sensor;
estimating a predicted posture change of the passenger based on the predicted driving operation and the densepose of the passenger; and
determining the necessity of the wearing of a seat belt of the passenger based on the predicted posture change.

11. The method of claim 1, wherein the interior vision sensor includes a depth sensor; and
wherein the determining the necessity of the wearing of a seat belt of the passenger comprises:
performing instance segmentation corresponding to the passenger by applying a third learning model based on machine learning to an image captured by photographing at least a portion of the body of the passenger by the depth sensor;
estimating a predicted posture change of the passenger based on a result obtained by performing the predicted driving operation and the instance segmentation; and
determining the necessity of the wearing of a seat belt of the passenger based on the predicted posture change.

12. A computer-readable recording medium having a stored computer program configured to cause a computer to execute the method of claim 1.

13. A vehicle control apparatus comprising:
a processor;
a vision sensor configured to photograph an interior of a vehicle;
a driving device configured to drive the vehicle; and
a memory operatively connected to the processor and configured to store at least one code executed by the processor,
wherein the memory stores a code configured to cause the processor to determine a predicted driving operation of the vehicle based on a predicted driving condition of the vehicle; determine necessity of wearing of a seat belt of the passenger and the wearing of a seat belt of the passenger based on an image of the passenger captured by the vision sensor and the predicted driving operation; and control the driving device based on a result obtained by determining the wearing of a seat belt of the passenger when the code is executed through the processor.

14. The vehicle control apparatus of claim 13, wherein the memory further stores map data; and
wherein the memory further stores a code configured to cause the processor to determine the predicted driving operation of the vehicle based on a predicted driving route of the vehicle, which is checked based on the map data.

15. The vehicle control apparatus of claim of claim 14, wherein the memory further stores a code configured to cause the processor to change the predicted driving operation in response to a result, obtained by determining the wearing of a seat belt of the passenger, indicating that the seat belt is not worn and control the driving device based on the changed predicted driving operation.

16. The vehicle control apparatus of claim of claim 15, wherein the memory further stores a code configured to cause the processor to change the predicted driving operation to a driving operation for reducing a degree of change of a predicted posture change of the passenger according to the predicted driving route.

17. The vehicle control apparatus of claim of claim 14, wherein the memory further stores a code configured to cause the processor to determine a predicted angular speed of the vehicle in response to a result indicating that the predicted driving route is a curved path, and determine the necessity of the wearing of a seat belt of the passenger based on a predicted posture change of the passenger, which is estimated according to the predicted angular speed.

18. The vehicle control apparatus of claim of claim 14, wherein the memory further stores a code configured to cause the processor to determine the necessity of the wearing of a seat belt based on a predicted posture change of the passenger estimated according to a gradient of the predicted driving route.

19. The vehicle control apparatus of claim of claim 13, wherein the memory further stores a code configured to cause the processor to estimate a predicted posture change of the passenger based on the predicted driving operation and densepose of the passenger estimated by applying a first learning model based on machine learning to an image captured by photographing at least a portion of the body of the passenger by the vision sensor, and determine the necessity of the wearing of a seat belt of the passenger based on the predicted posture change.

20. The vehicle control apparatus of claim of claim 13, wherein the vision sensor includes a depth sensor;
wherein the memory further stores a code configured to cause the processor to estimate a predicted posture change of the passenger based on the predicted driving operation and a result obtained by performing instance segmentation corresponding to the passenger by applying a second learning model based on machine learning to an image captured by photographing at least a portion of the body of the passenger by the depth sensor, and determine the necessity of the wearing of a seat belt of the passenger based on the predicted posture change.
